(19) United States
(12) Patent Application Publication
(10) Pub. No.: US 2007/0193637 A1
(43) Pub. Date: Aug. 23, 2007

(54) Systems and methods for controlling fluid flow

(75) Inventors: Raynald B. Cantin, Boise, ID (US); Dan Dynka, Meridian, ID (US)

Correspondence Address: PERKINS COIE LLP;PATENT-SEA, PO BOX 1247, SEATTLE, WA, 98111-1247, US

(73) Assignee: Micron Technology, Inc., Boise, ID (US)

(21) Appl. No.: 11/360,868

(22) Filed: Feb. 23, 2006

(51) Int. Cl. F16K 11/22

(52) U.S. Cl. 137/606

(57) ABSTRACT

Systems and methods for controlling fluid flow, including valve assemblies that control the flow of two or more fluids during microfeature workpiece processing, are disclosed herein. Certain aspects of the invention are directed toward a valve assembly having a compartment with an interior volume, a first inlet, a second inlet, and an outlet. The assembly further includes a first sealing element having an open position and a closed position and a second sealing element having an open position and a closed position. The second sealing element is located downstream of the first sealing element so that when the first sealing element is in the open position and the second sealing element is in the closed position, fluid can enter the interior volume through the first inlet, pass by a portion of the second sealing element while in the interior volume, and exit the interior volume via the outlet.

### TECHNICAL FIELD

The present invention is related to systems and methods for controlling fluid flow, including valve assemblies that control the flow of two or more fluids during microfeature workpiece processing and microfeature workpiece processing systems using such valve assemblies.

### BACKGROUND

During many types of microfeature workpiece processing, one or more valve assemblies are required to control the flow of various fluids. One such example includes thin film deposition processes or techniques. Thin film deposition techniques are widely used in the manufacturing of microfeatures to form a coating on a workpiece that closely conforms to the surface topography.

The size of the individual components in the workpiece is constantly decreasing, and the number of layers in the workpiece is increasing. As a result, both the density of components and the aspect ratios of depressions (i.e., the ratio of the depth to the size of the opening) are increasing. Thin film deposition techniques accordingly strive to produce highly uniform conformal layers that cover the sidewalls, bottoms, and corners in deep depressions that have very small openings.

One widely used thin film deposition technique is Chemical Vapor Deposition (CVD). In a CVD system, one or more precursors capable of reacting to form a solid thin film are mixed while in a gaseous or vaporous state, and then the precursor mixture is presented to the surface of the workpiece. The surface of the workpiece catalyzes the reaction between the precursors to form a solid thin film on the workpiece surface. A common way to catalyze the reaction at the surface of the workpiece is to heat the workpiece to a temperature that causes the reaction. CVD processes are routinely employed in many stages of manufacturing microelectronic components.

Atomic Layer Deposition (ALD) is another thin film deposition technique that is gaining prominence in manufacturing microfeatures on workpieces. In an ALD process, a first gas precursor is introduced into a chamber containing a workpiece, forming a layer of first gas molecules on the surface of the workpiece. The chamber is then purged with a purge gas to remove excess molecules of the first gas. During this purge process, a monolayer of first gas molecules is formed on the surface of the workpiece because the first gas molecules at the surface are held in place during the purge cycle by physical adsorption forces at moderate temperatures or chemisorption forces at higher temperatures. A second gas precursor is then introduced into the chamber. The first gas molecules on the surface of the workpiece react with the second gas molecules to form an extremely thin layer of solid material on the workpiece. For example, an ALD process can form a nanolayer that is typically less than 1 nm thick and usually less than 2 Å thick. The chamber is then purged again with the purge gas to remove excess second gas molecules.

Another type of ALD process is plasma ALD, in which energy is added to the gases inside the reaction chamber to form a plasma. A typical plasma ALD cycle includes (a) exposing the workpiece to a first gas precursor, (b) purging excess molecules from the processing vessel with a purge gas, (c) exposing the workpiece to a second gas precursor while generating a plasma in the processing vessel with a microwave or other energy generating device to cause the first and second gas molecules to react and form a layer of material on the workpiece, and (d) purging excess second gas molecules from the processing vessel. In actual processing, several cycles are repeated to build a thin film on a workpiece having the desired thickness. For example, each cycle may form a layer having a thickness of approximately 0.5-1.0Å, and thus several cycles are required to form a solid layer having a thickness of approximately 60 Å.

FIG. 1 is a partially schematic illustration of a current valve used in ALD processes. The valve shown in FIG. 1 includes multiple passageways and two diaphragms for controlling the flow of a purge gas and a precursor gas to an ALD reaction chamber. In FIG. 1, a first passageway 110a carries a purge gas to a first volume 120. A first diaphragm 125 is coupled to an actuator 150 and is located in the first volume 120. The first diaphragm 125 is shown in a retracted position so that the purge gas can flow through the first volume 120, through an outlet 122 of the first volume 120, and into a second passageway 110b. The first diaphragm 125 also has an extended position where the first diaphragm 125 seals the outlet 122, preventing the purge gas from flowing into the second passageway

The valve also has a third passageway 110c that carries a precursor gas to a second volume 130. A second diaphragm 135 is coupled to an actuator 150 and located in the second volume 130. The second diaphragm 135 is shown in an extended position where the second diaphragm 135 seals an outlet 132 of the second volume 130 to prevent the precursor gas from flowing into a fourth passageway 110d. The second diaphragm 135 also has a retracted position so that the precursor gas can flow through the second volume 130, through the outlet 132, and into the fourth passageway 110d. The second and fourth passageways 110b and 110d converge into a fifth passageway 110e that is in fluid communication with an ALD reaction chamber.

During the ALD process, the first diaphragm 125 is extended to close the outlet 122 and the second diaphragm 135 is retracted so that a first precursor follows a flow path through the third passageway 110c, the second volume 130, the fourth passageway 110d, and the fifth passageway 110e to the reaction chamber. The second diaphragm 135 is then extended to close the outlet 132 and the first diaphragm 125 is retracted so that the purge gas follows a flow path through the first passageway 110a, the first volume 120, the second passageway 110b, and the fifth passageway 110e to the reaction chamber.

As the purge gas flows to the reaction chamber, the purge gas does not “back” flow into the fourth passageway 110d where the second and fourth passageways 110b and 110d merge because the outlet 132 of the second volume 130 is sealed by the second diaphragm 135. Accordingly, a residual amount of first precursor remains in the fourth passageway 110d from when the second diaphragm 135 was retracted, preventing the purge gas from flowing into the fourth passageway 110d. A venturi VT is located at the merger of the second and fourth passageways 110b and 110d so that the purge gas flowing through the second passageway 110b into the fifth passageway 110e creates a low pressure area that will partially evacuate the residual first precursor in the fourth passageway 110d. The fourth passageway 110d cannot be fully evacuated or purged because the opposite end of the fourth passageway 110d is sealed at the outlet 132 of the second volume 130 and the venturi action cannot produce a complete vacuum.

After the purge gas has passed through the valve and into the chamber the first diaphragm is extended to stop the flow of purge gas. A second valve similar to the valve shown in FIG. 1 then introduces a second precursor into the chamber that will interact with the first precursor to form a layer of material on a workpiece. Because the fourth passageway 110d of the valve shown in FIG. 1 is in communication with the reaction chamber, any residual first precursor that remained in the fourth passageway 110d after the flow of purge gas can be exposed to the environment in the reaction chamber when the second precursor is introduced. This environment can include second precursor gas molecules and high temperatures, both of which can chemically affect the remaining residual first precursor. For example, high temperatures can cause chemical decomposition of the first precursor, and second precursor molecules can react with first precursor molecules to form particles. Accordingly, the quality, concentration, uniformity, and growth rate of material deposited on the workpiece during the current ALD cycle and subsequent ALD cycles can be affected by the residual gases in the valves.

FIG. 2 is a partially schematic illustration of another valve currently used in ALD processes. The valve shown in FIG. 2 includes multiple passageways and two diaphragms for controlling the flow of a purge gas and a precursor gas to an ALD reaction chamber. In FIG. 2, a first passageway 210a carries a purge gas to a first volume 220. A first diaphragm 225 is coupled to an actuator 250 and is located in the first volume 220. The first diaphragm 225 is shown in an extended position where the first diaphragm 225 seals an outlet 222 of the first volume 220 to prevent the purge gas from flowing into a second passageway 210b. The first diaphragm 225 also has a retracted position in which the purge gas can flow through the first volume 220, through the outlet 222, and into the second passageway 210b.

The valve in FIG. 2 also has a third passageway 210c that carries a precursor gas to a second volume 230. A second diaphragm 235 is coupled to an actuator 250 and located in the second volume 230. The second diaphragm 235 is shown in a retracted position so that the precursor gas can flow through the second volume 230, through an outlet 232 of the second volume 230, and into a fourth passageway 210d. The second diaphragm 235 also has an extended position where the second diaphragm 235 seals the outlet 232 to prevent the precursor gas from flowing into the fourth passageway 210d. The second and fourth passageways 210b and 210d converge into a fifth passageway 210e that is in fluid communication with an ALD reaction chamber.

During the ALD process, the first diaphragm 225 is extended and the second diaphragm 235 is retracted so that a first precursor follows a flow path through the third passageway 210c, the second volume 230, the fourth passageway 210d, and the fifth passageway 210e to the reaction chamber. The second diaphragm 235 is then extended and the first diaphragm 225 is retracted so that the purge gas follows a flow path through the first passageway 210a, the first volume 220, the second passageway 210b, and the fifth passageway 210e to the reaction chamber.

As discussed above with reference to FIG. 1, as the purge gas flows to the reaction chamber the purge gas does not “back” flow into the fourth passageway 210d because the outlet 232 of the second volume 230 is sealed by the second diaphragm 235. A venturi VT is located at the merger of the second and fourth passageways 210b and 210d so that the purge gas flowing through the second passageway 210b into the fifth passageway 210e creates a low pressure area that will partially evacuate the residual first precursor in the fourth passageway 210d. However, the fourth passageway 210d cannot be fully evacuated because the outlet 232 is sealed.

After the purge gas has passed through the valve and into the chamber, the first diaphragm is extended to stop the flow of purge gas, and a second valve introduces a second precursor into the chamber that will interact with the first precursor to form a layer of material on a workpiece. Because the fourth passageway 210d of the valve shown in FIG. 2 is in communication with the reaction chamber, any residual first precursor that remained in the fourth passageway 210d after the flow of purge gas can be exposed to the environment in the reaction chamber when the second precursor is introduced. This environment can include second precursor gas molecules and high temperatures, both of which can chemically affect the remaining residual first precursor.

Accordingly, the quality, concentration, uniformity, and growth rate of material deposited on the workpiece during the current ALD cycle and subsequent ALD cycles can be affected by this type of valve as well.

### BRIEF DESCRIPTION OF THE DRAWINGS

FIGS. 1 and 2 are partially schematic cross-sectional views of valves used in current ALD processes in accordance with the prior art.

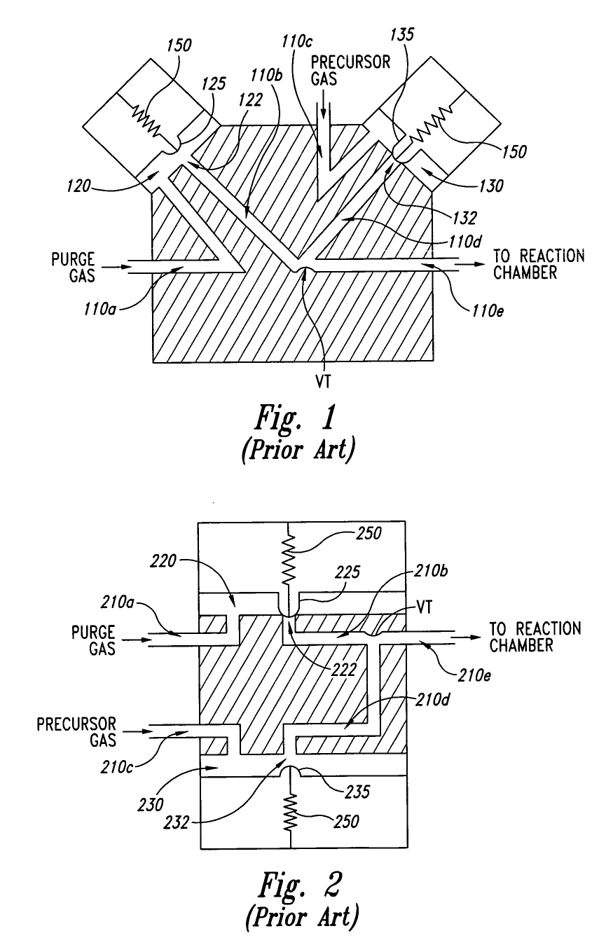

FIGS. 3 and 4 are partially schematic cross-sectional views of a valve assembly for controlling the flow of at least two fluids for use in processing a microfeature workpiece in accordance with embodiments of the invention.

FIGS. 5 and 6 are partially schematic cross-sectional views of a valve assembly for controlling the flow of at least two fluids for use in processing a microfeature workpiece in accordance with other embodiments of the invention.

FIG. 7 is a partially schematic cross-sectional view of a valve assembly for controlling the flow of at least three fluids for use in processing a microfeature workpiece in accordance with still other embodiments of the invention.

FIG. 8 is a partially schematic cross-sectional view of a microfeature workpiece processing system having at least one valve assembly that controls the flow of at least two fluids, in accordance with yet other embodiments of the invention.

### DETAILED DESCRIPTION

A. Overview

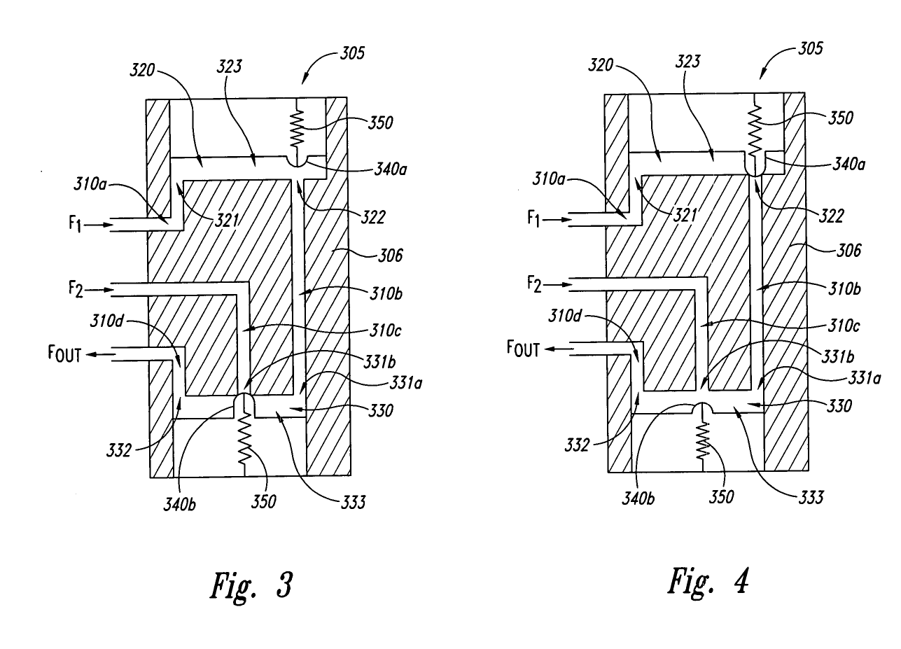

The following disclosure describes several embodiments of systems and methods for controlling fluid flow, including valve assemblies that control the flow of two or more fluids during microfeature workpiece processing and microfeature workpiece processing systems using such valve assemblies. Many specific details of the invention are described below with reference to single-wafer reaction chambers for depositing materials onto microfeature workpieces, but several embodiments can be used in batch systems for processing a plurality of workpieces simultaneously. The term “microfeature workpiece” is used throughout to include substrates upon which and/or in which microelectronic devices, micromechanical devices, data storage elements, read/write components, and other features are fabricated. For example, microfeature workpieces can be semiconductor wafers such as silicon or gallium arsenide wafers, glass substrates, insulative substrates, and many other types of materials. Furthermore, the term “fluid” is used throughout to include any form of matter that has no fixed shape, including liquids, gases, slurries, plasmas, and vapors. Several embodiments in accordance with the invention are set forth in FIGS. 3-8 and the following text to provide a thorough understanding of particular embodiments of the invention. A person skilled in the art will understand, however, that the invention may have additional embodiments, or that the invention may be practiced without several of the details of the embodiments shown in FIGS. 3-8.

Certain aspects of the invention are directed toward a valve assembly for controlling the flow of at least two fluids for use in processing a microfeature workpiece. The assembly includes a body and a compartment carried by the body. The compartment has an interior volume configured to carry a fluid, a first inlet configured to allow fluid to enter the interior volume, a second inlet configured to allow fluid to enter the interior volume, and an outlet configured to allow fluid to exit the interior volume. The assembly further includes a first passageway coupled to the first inlet, a second passageway coupled to the second inlet, and a first sealing element movable between an open position and a closed position. In the open position the first sealing element is positioned so that the first passageway is in fluid communication with the interior volume of the compartment via the first inlet. In the closed position the first sealing element is positioned to inhibit fluid flow through the first passageway into the interior volume of the compartment. The assembly still further includes a second sealing element movable between an open position and a closed position. In the closed position the second sealing element is positioned to block the second inlet to inhibit fluid flow through the second inlet. In the open position, the second sealing element is positioned so that the second passageway is in fluid communication with the interior volume of the compartment via the second inlet. In the open position, a portion of the second sealing element is within the interior volume of the compartment or forms a portion of the surface defining the interior volume of the compartment.

Other aspects of the invention are directed toward a valve assembly for controlling the flow of at least two fluids for use in processing a microfeature workpiece. The assembly includes a body and a compartment carried by the body. The compartment has an interior volume configured to carry a fluid, a first inlet configured to allow fluid to enter the interior volume, a second inlet configured to allow fluid to enter the interior volume, and an outlet configured to allow fluid to exit the interior volume. The assembly further includes a first passageway coupled to the first inlet, a second passageway coupled to the second inlet, and a first sealing element movable between an open position and a closed position. In the open position the first sealing element is positioned so that the first passageway is in fluid communication with the interior volume of the compartment via the first inlet. In the closed position the first sealing element is positioned to inhibit fluid flow through the first passageway into the interior volume of the compartment. The assembly still further includes a second sealing element movable between an open position and a closed position. In the closed position the second sealing element is positioned to block the second inlet to inhibit fluid flow through the second inlet. In the open position, the second sealing element is positioned so that the second passageway is in fluid communication with the interior volume of the compartment via the second inlet. The second sealing element is located downstream of the first sealing element and configured so that when the first sealing element is in the open position and the second sealing element is in the closed position, fluid can enter the interior volume through the first inlet, pass by a portion of the second sealing element while in the interior volume, and exit the interior volume via the outlet.

Still other aspects of the invention are directed toward a microfeature workpiece processing system having a valve assembly that controls the flow of at least two fluids. The system includes a processing chamber configured to hold a microfeature workpiece during processing, a first fluid reservoir, a second fluid reservoir, and a valve assembly operably coupled to the processing chamber, the first fluid reservoir, and the second fluid reservoir. The valve assembly includes a body and a compartment carried by the body. The compartment has an interior volume configured to carry fluid, a first inlet configured to allow fluid to enter the interior volume, a second inlet configured to allow fluid to enter the interior volume, and an outlet configured to allow fluid to exit the interior volume. The outlet is coupled to the processing chamber. The valve assembly further includes a first passageway coupled to the first inlet and the first fluid reservoir. The first passageway is configured to carry a first fluid to the first inlet. The valve assembly still further includes a second passageway coupled to the second inlet and the second fluid reservoir. The second passageway is configured to carry a second fluid to the second inlet. The valve assembly yet further includes a first sealing element movable between an open position and a closed position. In the open position, the first sealing element is positioned so that the first passageway is in fluid communication with the interior volume of the compartment via the first inlet. In the closed position, the first sealing element is positioned to inhibit fluid flow through the first passageway into the interior volume of the compartment. The valve assembly still further includes a second sealing element movable between an open position and a closed position. In the closed position, the second sealing element is positioned to block the second inlet to inhibit fluid flow through the second inlet. In the open position, the second sealing element is positioned so that the second passageway is in fluid communication with the interior volume of the compartment via the second inlet. In the open position a portion of the second sealing element is within the interior volume of the compartment or forms a portion of the surface defining the interior volume of the compartment.

Yet other aspects of the invention are directed toward a microfeature workpiece processing system having a valve assembly that controls the flow of at least two fluids. The system includes a processing chamber configured to hold a microfeature workpiece during processing, a first fluid reservoir, a second fluid reservoir, and a valve assembly operably coupled to the processing chamber, the first fluid reservoir, and the second fluid reservoir. The valve assembly includes a body and a compartment carried by the body. The compartment has an interior volume configured to carry fluid, a first inlet configured to allow fluid to enter the interior volume, a second inlet configured to allow fluid to enter the interior volume, and an outlet configured to allow fluid to exit the interior volume. The outlet is coupled to the processing chamber. The valve assembly further includes a first passageway coupled to the first inlet and the first fluid reservoir. The first passageway is configured to carry a first fluid to the first inlet. The valve assembly still further includes a second passageway coupled to the second inlet and the second fluid reservoir. The second passageway is configured to carry a second fluid to the second inlet. The valve assembly yet further includes a first sealing means having an open position and a closed position. When the first sealing means is in the open position the first passageway is in fluid communication with the interior volume of the compartment via the first inlet. When the first sealing means is in the closed position the first sealing means inhibits fluid flow through the first passageway into the interior volume of the compartment. The valve assembly still further includes a second sealing means movable between an open position and a closed position. When the second sealing means is in the open position the second passageway is in fluid communication with the interior volume of the compartment via the second inlet. When the second sealing means is in the closed position the second inlet is blocked to inhibit fluid flow through the second inlet. The second sealing means is located downstream of the first sealing means and is configured so that when the first sealing means is in the open position and the second sealing means is in the closed position, a first fluid can enter the interior volume via the first inlet, flow past at least a portion of the second sealing means while in the interior volume, and exit the interior volume via the outlet.

Still other aspects of the invention are directed toward a method for making a valve assembly for controlling the flow of at least two fluids for use in processing a microfeature workpiece. The method includes forming a compartment in a body. The compartment has an interior volume configured to carry a fluid, a first inlet configured to allow fluid to enter the interior volume, a second inlet configured to allow fluid to enter the interior volume, and an outlet configured to allow fluid to exit the interior volume. The method further includes coupling a first passageway to the first inlet, coupling a second passageway to the second inlet, and locating a first sealing element relative to the first passageway and the first inlet to control fluid flow through the first inlet. The first sealing element is movable between an open position and a closed position. In the open position, the first sealing element is positioned so that the first passageway is in fluid communication with the interior volume of the compartment via the first inlet. In the closed position the first sealing element is positioned to inhibit fluid flow through the first passageway into the interior volume of the compartment. The method still further includes locating a second sealing element relative to the compartment and the second inlet to control fluid flow through the second inlet. The second sealing element is movable between an open position and a closed position. In the closed position, the second sealing element is positioned to block the second inlet to inhibit fluid flow through the second inlet. In the open position, the second sealing element is positioned so that the second passageway is in fluid communication with the interior volume of the compartment via the second inlet. In the open position, a portion of the second sealing element is within the interior volume of the compartment or forms a portion of the surface defining the interior volume of the compartment.

Yet other aspects of the invention are directed toward a method for making a valve assembly for controlling the flow of at least two fluids for use in processing a microfeature workpiece. The method includes forming a compartment in a body. The compartment has an interior volume configured to carry a fluid, a first inlet configured to allow fluid to enter the interior volume, a second inlet configured to allow fluid to enter the interior volume, and an outlet configured to allow fluid to exit the interior volume. The method further includes coupling a first passageway to the first inlet, coupling a second passageway to the second inlet, and locating a first sealing element relative to the first passageway and the first inlet to control fluid flow through the first inlet. The first sealing element is movable between an open position and a closed position. In the open position, the first sealing element is positioned so that the first passageway is in fluid communication with the interior volume of the compartment via the first inlet. In the closed position, the first sealing element is positioned to inhibit fluid flow through the first passageway into the interior volume of the compartment. The method still further includes locating a second sealing element relative to the compartment and the second inlet to control fluid flow through the second inlet. The second sealing element is movable between an open position and a closed position. In the closed position, the second sealing element is positioned to block the second inlet to inhibit fluid flow through the second inlet. In the open position, the second sealing element is positioned so that the second passageway is in fluid communication with the interior volume of the compartment via the second inlet. The second sealing element is located downstream of the first sealing element and configured so that when the first sealing element is in the open position and the second sealing element is in the closed position, fluid can enter the interior volume through the first inlet, pass by a portion of the second sealing element while in the interior volume, and exit the interior volume via the outlet.

Still other aspects of the invention are directed toward a method for controlling the flow of at least two fluids for use in processing a microfeature workpiece. The method includes moving a first sealing element to a closed position where the first sealing element inhibits a first fluid from flowing through a first inlet of a compartment into an interior volume of the compartment. The method further includes moving a second sealing element to an open position where a second fluid is allowed to flow through a second inlet of the compartment into the interior volume of the compartment and exit the interior volume via an outlet of the compartment. The method still further includes moving the second sealing element to a closed position where the second sealing element blocks the second inlet to inhibit the second fluid from flowing through the second inlet. The method yet further includes moving the first sealing element to an open position where the first sealing element allows the first fluid to flow through the first inlet. The second sealing element is located downstream of the first sealing element and configured so that when the first sealing element is in the open position and the second sealing element is in the closed position, the first fluid enters the interior volume through the first inlet, passes by a portion of the second sealing element while in the interior volume, and exit the interior volume via the outlet.

B. Embodiments of Valve Assemblies for Controlling the Flow of at Least Two Fluids for use in Processing a Microfeature Workpiece and Associated Methods

FIGS. 3 and 4 are partially schematic cross-sectional views of a valve assembly 305 for controlling the flow of at least two fluids for use in processing a microfeature workpiece in accordance with embodiments of the invention. In FIG. 3, the valve assembly 305 includes a body 306 with a first compartment 320 and a second compartment 330. The first compartment 320 includes a first interior volume 323 configured to carry fluid, an inlet 321 in fluid communication with a first passageway 310a, and an outlet 322 coupled to a second passageway 310b. The second compartment 330 includes a second interior volume 333 configured to carry fluid, a first inlet 331a in fluid communication with the second passageway 310b, a second inlet 331b coupled to a third passageway 310c, and an outlet in fluid communication with a fourth passageway 310d.

In the illustrated embodiment, the valve assembly 305 includes a first sealing element 340a located within or proximate to the first interior volume 323 of the first compartment 320 and a second sealing element 340b located within or proximate to the second interior volume 333 of the second compartment 330. The first sealing element 340a is coupled to an actuator 350 and is movable between open and closed positions to control a flow of a first fluid F1 through the valve assembly 305. The second sealing element 340b is coupled to an actuator 350 and is movable between open and closed positions to control a flow of a second fluid F2 through the valve assembly 305. In the illustrated embodiment the actuator 350 coupled to the first sealing element 340a is a different actuator than the actuator 350 coupled to the second sealing element 340b. In other embodiments the same actuator 350 can be coupled to both the first and second sealing elements 340a and 340b.

For example, in FIGS. 3 and 4 when the first sealing element 340a is in the open position (shown in FIG. 3), the first sealing element 340a is positioned so that the second passageway 310b is in fluid communication with the first interior volume 323 of the first compartment 320 via the outlet 322 of the first compartment 320 and the second interior volume 333 of the second compartment 330 via the first inlet 331a of the second compartment 330. In the open position, at least a portion of the first sealing element 340a is within the first interior volume 323 of the first compartment 320 or forms a portion of the surface defining the first interior volume 323. In the closed position (shown in FIG. 4), the first sealing element 340a is positioned to inhibit or prevent substantial fluid flow through the second passageway 310b into the second interior volume 333 of the second compartment 330. For example, in the closed position the first sealing element 340a can be positioned to block the outlet 322 of the first compartment 320, thereby preventing substantial fluid flow through the outlet 322 (e.g., preventing all fluid flow or allowing only a small amount of fluid flow through the outlet).

As discussed above, in FIGS. 3 and 4 the second sealing element 340b is also movable between an open position (shown in FIG. 4) and a closed position (shown in FIG. 3). In the open position, the second sealing element 340b is positioned so that the third passageway 310c is in fluid communication with the second interior volume 333 via the second inlet 331b of the second compartment 330. In the open position, at least a portion of the second sealing element 340b is within the second interior volume 333 of the second compartment 330 or forms a portion of the surface defining the second interior volume 333. In the closed position, the second sealing element 340b is positioned to inhibit or prevent substantial fluid flow through the third passageway 310c into the second interior volume 333. For example, in the closed position the second sealing element 340b can be positioned to block the second inlet 331b of the second compartment 330, thereby inhibiting fluid flow from the third passageway 310c through the second inlet 331b into the second interior volume 333.

In the illustrated embodiment, the second sealing element 340b is located downstream of the first sealing element 340a (e.g., downstream in the flow path of the first fluid F1). For example, when the first sealing element 340a is in the open position and the second sealing element 340b is in the closed position (as shown in FIG. 3), the flow path of the first fluid F1 is through the first passageway 310a, through the inlet 321 of the first compartment 320, through the first interior volume 323, through the outlet 322 of the first compartment 320, through the second passageway 310b, and through the first inlet 331a of the second compartment 330 into the second interior volume 333. In FIGS. 3 and 4, the second sealing element 340b is configured so that when the second sealing element 340b is in the closed position, the first fluid F1 can flow through the second interior volume 333, flow past a portion of the second sealing element 340b, and exit the second interior volume 333 via an outlet 332 of the second compartment 330. For example, in the illustrated embodiment the second sealing element 340b is configured so that the first fluid can flow around at least a portion of a surface of the second sealing element 340b and/or around at least one side of the second sealing element 340b. In FIG. 3, because the second sealing element 340b is in the closed position, the second fluid F2 is inhibited from entering the second interior volume 333.

The flow of the first fluid F1 can be stopped or inhibited by moving the first sealing element 340a to the closed position, thereby preventing the first fluid F1 from flowing into the second interior volume 333 of the second compartment 330.

The second sealing element 340b can then be moved to the open position (as shown in FIG. 4) to allow the second fluid F2 to flow through the third passageway 310c, the second inlet 331b of the second compartment 330, the second interior volume 333, the outlet 332 of the second compartment 330, and the fourth passageway 310d.

The second sealing element 340b can then be moved to the closed position to inhibit the flow of the second fluid F2 into the second interior volume 333 of the second compartment 330. The first sealing element 340a can then be opened, allowing the first fluid F1 to flow into the second interior volume 333, flow through the second interior volume 333 past at least a portion of the second sealing element 340b, and exit the second interior volume 333 via the outlet 332 of the second compartment 330. The process described above can be repeated multiple times, for example, when controlling the flow of a reactant or precursor fluid and a purge fluid for an ALD process. For instance, where F2 is a precursor fluid and F1 is a purge fluid, the process described above can be used to purge the second interior volume 333 of the second compartment 330 in between precursor applications. As discussed below in further detail, in certain embodiments a second valve assembly, similar to the valve assembly 305 shown in FIG. 3, can be used to provide a second reactant or precursor and a second purge source.

A feature of some of the embodiments described above is that the valve assembly can have a smaller interior volume than valves currently used in various microfeature workpiece processes (e.g., CVD or ALD processes). For instance, in certain embodiments discussed above the number of passageways can be reduced and/or various components can be moved closer together as compared to current valves. For example, current valves typically use ¼ inch porting and have interior volumes in the order of 0.5 cubic inches or larger. In selected embodiments discussed above, it is anticipated that the valve assembly can use ⅛ inch porting and can have interior volumes in the order of 0.01-0.06 cubic inches or smaller.

An advantage of lower interior volume is that the ramp-up and ramp-down time required to start and stop fluid flow can be decreased, thereby improving the throughput of an associated process using the fluids controlled by the valve assembly. Another advantage of lower interior volume is that the distance and time required for fluid to travel from a reservoir through the valve can be reduced, thereby decreasing the potential or the chemical properties of the fluid to be affected between storage and use.

Another feature of some of the embodiments described above is that the valve assembly can be quickly and/or effectively purged when the valve assembly is used for processes where one of the fluids controlled by the valve assembly is a purge fluid. For example, as discussed above with reference to FIGS. 3 and 4, in certain embodiments where F2 is a precursor fluid and F1 is a purge fluid, the process described above can be used to purge the second interior volume 333 of the second compartment 330 in between precursor applications. In selected embodiments, after the precursor has passed through the second interior volume 333 of the valve assembly, the second sealing element 340b can be moved to the closed position, inhibiting the precursor from entering the second interior volume 333 (e.g., isolating the precursor from the second interior volume 333). The first sealing element 340a can then be moved to the open position, thereby allowing the flow or pressure of the purge fluid to purge the second interior volume 333.

Because the purge fluid flows through the second interior volume, around the second sealing element 340b, the valve assembly 305 can be purged more quickly and completely using the flow or pressure of the purge fluid than can be done using the venturi arrangement of current valves. Additionally, because the precursor is substantially isolated from the second interior volume 333, after the second interior volume 333 has been purged, there is little or no residual precursor that is exposed to the environment of a processing chamber when the outlet 332 of the second compartment 330 is in fluid communication with the processing chamber.

An advantage of this feature is that a processing chamber using the valve assembly shown in FIGS. 3 and 4 can have greater throughput because the purge can be completed more quickly. Additionally, in the case of a microfeature workpiece deposition process, a higher quality film can be deposited on the workpiece because after the purge process there can be little or no residual precursor in, or proximate to, the valve assembly. Accordingly, there is little or no residual precursor to react with a second precursor to inadvertently form particles near or in the valve assembly. Additionally, there is little or no residual precursor to be chemically affected by exposure to the processing chamber environment (e.g., chemical decomposition) and subsequently used in the next application of precursor via the valve assembly. Furthermore, because there can be fewer particles inadvertently formed in, or proximate to, the valve assembly, the downtime required for cleaning and/or maintenance can be decreased, thereby increasing the availability of the processing chamber associated with the valve assembly.

Yet another feature of the valve assembly is that it can be scalable. For example, in some embodiments the valve assembly can be a microcomponent. In other embodiments, the valve assembly can be made as large as necessary to control fluid flow in large scale fluid processes. An advantage of this feature is that very large valve assemblies can be made that provide quick ramp up and ramp down times and/or that can be quickly and effectively purged depending on the specific application in which the valve assembly is used.

C. Additional Embodiments of Valve Assemblies for Controlling the Flow of at Least Two Fluids for Use in Processing a Microfeature Workpiece and Associated Methods

In other embodiments, the valve assembly 305 discussed above with reference to FIGS. 3 and 4 can have other arrangements, including more, fewer, and/or different components. For example, in certain embodiments the first sealing element 340a and/or the second sealing element 340b can include a diaphragm made from a flexible material, a plunger type device, or other types of valve components. Additionally, in other embodiments the first sealing element 340a and/or the second sealing element 340b can include additional positions, for example, the sealing elements can include one or more intermediate positions that allow restricted flow through the associated inlet or outlet as compared to the open position. Furthermore, in still other embodiments the first sealing element 340a and the second sealing element 340b can include additional combinations of positions. For example, in selected embodiments the first and second sealing elements 340a and 340b can both be placed to the open position at the same time.

Additionally, although the various components of the valve assembly 305 shown in FIGS. 3 and 4 are carried by a single body or housing, in other embodiments various components of the valve assembly 305 can be distributed between multiple bodies and/or be freestanding. For example, in some embodiments certain passageways can be free standing as they extend between various components. Furthermore, in selected embodiments the valve assembly 305 can have various types of actuators, including pneumatic, hydraulic, and/or electric actuators. In selected embodiments multiple actuators can be coupled to a single sealing element, and/or an actuator can be configured to move a sealing element in multiple directions. For example, in certain embodiments a sealing element can include a diaphragm and an actuator can be configured to move the diaphragm in multiple directions to alternately block multiple different inlets or outlets.

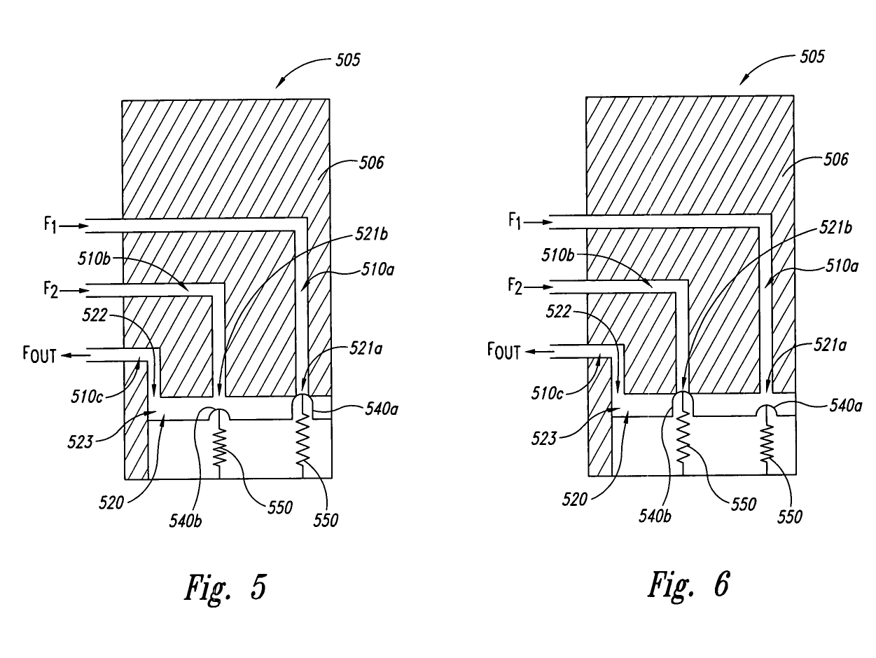

FIGS. 5 and 6 are partially schematic cross-sectional views of a valve assembly 505 for controlling the flow of at least two fluids for use in processing a microfeature workpiece in accordance with other embodiments of the invention. In FIG. 5, the valve assembly 505 includes a body 506 that carries a compartment 520 with an interior volume 523 configured to carry fluid, a first inlet 521a coupled to a first passageway 510a, a second inlet 521b coupled to a second passageway 510b, and an outlet 522 coupled to a third passageway 510c.

In the illustrated embodiment, a first sealing element 540a and a second sealing element 540b are located within or proximate to the interior volume 523 of the compartment 520. The first sealing element 540a is coupled to an actuator 550 and is movable between open and closed positions to control a first fluid F1 through the valve assembly 505. The second sealing element is coupled to an actuator 550 and is movable between open and closed positions to control the flow of a second fluid F2 through the valve assembly 505.

For example, in FIGS. 5 and 6 when the first sealing element 540a is in the open position (shown in FIG. 6), the first sealing element 540a is positioned so that the first passageway 510a is in fluid communication with the interior volume 523 of the compartment 520 via the first inlet 521a. In the open position, at least a portion of the first sealing element 540a is within the interior volume 523 of the compartment 520 or forms a portion of the surface defining the interior volume 523. In the closed position, the first sealing element 540a is positioned to inhibit or prevent substantial fluid flow through the first passageway 510a into the interior volume 523 of the compartment 520. For example, in the closed position the first sealing element 540a can be positioned to block the first inlet 521a, thereby preventing substantial fluid flow through the first inlet 521a.

As discussed above, in FIGS. 5 and 6, the second sealing element 540b is also movable between an open position (shown in FIG. 5) and a closed position (shown in FIG. 6). In the open position, the second sealing element 540b is positioned so that the second passageway 510b is in fluid communication with the interior volume 523 of the compartment 520 via the second inlet 521b. In the open position, at least a portion of the second sealing element 540b is within the interior volume 523 of the compartment 520 or forms a portion of the surface defining the interior volume 523. In the closed position, the second sealing element 540b is positioned to inhibit or prevent substantial fluid flow through the second passageway 510b into the interior volume 523 of the compartment 520.

For example, in the closed position the second sealing element 540b can be positioned to block the second inlet 521b, thereby inhibiting fluid flow from the second passageway 510b, through second inlet 521b, and into the interior volume 523.

In the illustrated embodiment, the second sealing element 540b is located downstream of the first sealing element 540a (e.g., downstream in the flow path of the first fluid F1). For example, when the first sealing element 540a is in the open position and the second sealing element 540b is in the closed position (as shown in FIG. 6), the flow path of the first fluid F1 is through the first passageway 510a, through the first inlet 521a, and into the interior volume 523. In FIGS. 5 and 6, the second sealing element 540b is configured so that when the second sealing element 540b is in the closed position, the first fluid F1 can flow through the interior volume 523, flow past a portion of the second sealing element 540b, and exit the interior volume 523 via the outlet 522. In FIG. 6, because the second sealing element 540b is in the closed position, the second fluid F2 is inhibited from entering the interior volume 523.

The flow of the first fluid F1 can be stopped or inhibited by moving the first sealing element 540a to the closed position. The second sealing element 540b can then be moved to the open position (as shown in FIG. 5) to allow the second fluid F2 to flow through the second passageway 510b, through the second inlet 521b, through the interior volume 523, through the outlet 522, and into the third passageway 510c. The second sealing element 540b can then be moved to the closed position to inhibit the flow of the second fluid F2 into the interior volume 523. The first sealing element 540a can then be opened allowing the first fluid F1 to flow into the interior volume 523, as discussed above. The process described above can be repeated multiple times, for example, when controlling the flow of a reactant or precursor fluid and a purge fluid for an ALD process. For instance, where F2 is a precursor fluid and F1 is a purge fluid, the process described above can be used to purge the interior volume 523 in between precursor applications.

Features and advantages of embodiments discussed above with reference to FIGS. 5 and 6 are similar to those discussed above with reference to FIGS. 3 and 4. Additionally, in other embodiments the valve assembly 505 discussed above with reference to FIGS. 5 and 6 can have other arrangements, including more, fewer, and/or different components. For instance, in other embodiments the valve assembly can include more than two sealing elements.

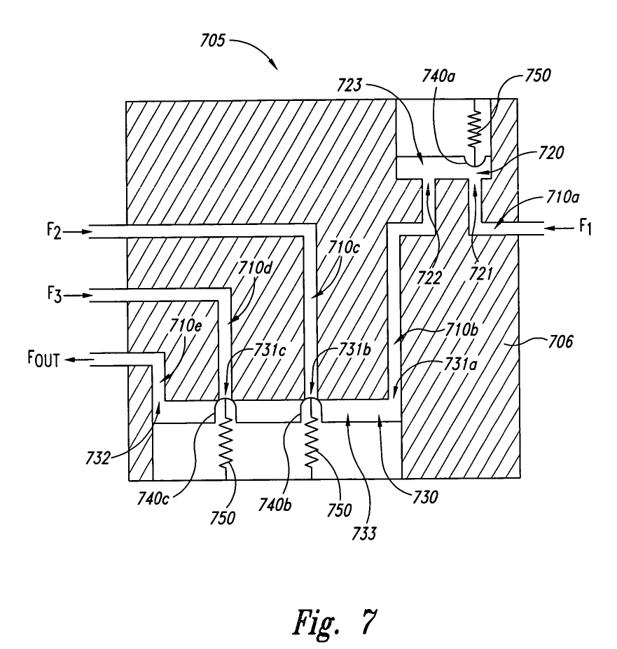

For example, FIG. 7 is a partially schematic cross-sectional view of a valve assembly 705 having three sealing elements 740a-c for controlling the flow of at least three fluids for use in processing a microfeature workpiece in accordance with still other embodiments of the invention. In FIG. 7, the valve assembly 705 includes a body 706 that carries a first compartment 720 and a second compartment 730. The first compartment 720 includes a first interior volume 723 configured to carry fluid, an inlet 721 in fluid communication with a first passageway 710a, and an outlet 722 coupled to a second passageway 710b.

The second compartment 730 includes a second interior volume 733 configured to carry fluid, a first inlet 731a in fluid communication with the second passageway 710b, a second inlet 731b coupled to a third passageway 710c, a third inlet 731c coupled to a fourth passageway 710d and an outlet 732 in fluid communication with a fifth passageway 710e.

In the illustrated embodiment, a first sealing element 740a is located within or proximate to the first interior volume 723 of the first compartment 720, and a second sealing element 740b and a third sealing element 740c are located within or proximate to the second interior volume 733 of the second compartment 730.

The first sealing element 740a is coupled to an actuator 750 and is movable between open and closed positions to control a flow of a first fluid F1 through the valve assembly 705. The second sealing element 740b is coupled to an actuator 750 and is movable between open and closed positions to control a flow of a second fluid F2 through the valve assembly 705. The third sealing element 740c is coupled to an actuator 750 and is movable between open and closed positions to control a flow of a third fluid F3 through the valve assembly 705.

For example, in FIG. 7 the first sealing element 740a is movable between an open position (shown in FIG. 7) and a closed position. In the open position, the first sealing element 740a is positioned so that the first passageway is in fluid communication with the second interior volume 733 via the inlet 721 of the first compartment 720, the first interior volume 723, the outlet 722 of the first compartment 720, the second passageway 710b, and the first inlet 731a of the second compartment 730. In the open position, at least a portion of the first sealing element 740a is within the first interior volume 723 of the first compartment 720 or forms a portion of the surface defining the first interior volume 723. In the closed position, the first sealing element 740a is positioned to inhibit or prevent substantial fluid flow from the first passageway 710a through the inlet 721 of the first compartment 720 into the first interior volume 723. For example, in the closed position the first sealing element 740a can be positioned to block the inlet 721 of the first compartment 720, thereby preventing substantial fluid flow through the inlet 721 (e.g., preventing all fluid flow or allowing only a small amount of fluid flow through the outlet).

In FIG. 7, the second sealing element 740b is also movable between an open position and a closed position (shown in FIG. 7). In the open position, the second sealing element 740b is positioned so that the third passageway 710c is in fluid communication with the second interior volume 733 via the second inlet 731b of the second compartment 730. In the open position, at least a portion of the second sealing element 740b is within the second interior volume 733 of the second compartment 730 or forms a portion of the surface defining the second interior volume 733. In the closed position, the second sealing element 740b is positioned to inhibit or prevent substantial fluid flow from the third passageway 710c into the second interior volume 733. For example, in the closed position the second sealing element 740b can be positioned to block the second inlet 731 b of the second compartment 730, thereby inhibiting fluid flow from the third passageway 710c through second inlet 731b into the interior volume 733.

Similarly, in the illustrated embodiment the third sealing element 740c is also movable between an open position and a closed position (shown in FIG. 7). In the open position, the third sealing element 740c is positioned so that the fourth passageway 710d is in fluid communication with the second interior volume 733 via the third inlet 731c of the second compartment 730. In the open position, at least a portion of the third sealing element 740c is within the second interior volume 733 of the second compartment 730 or forms a portion of the surface defining the second interior volume 733. In the closed position, the third sealing element 740c is positioned to inhibit or prevent substantial fluid flow from the fourth passageway 710d into the second interior volume 733. For example, in the closed position the third sealing element 740c can be positioned to block the third inlet 731c of the second compartment 730, thereby inhibiting fluid flow from the fourth passageway 710d through third inlet 731c into the second interior volume 733.

In FIG. 7, the second and third sealing elements 740b and 740c are located downstream of the first sealing element 740a (e.g., downstream in the flow path of the first fluid F1). For example, when the first sealing element 740a is in the open position, and the second and third sealing elements 740b and 740c are in the closed position (as shown in FIG. 7), the flow path of the first fluid F1 is through the first passageway 710a, the inlet 721 of the first compartment 720, the first interior volume 723, the outlet 722, the second passageway 710b, and the first inlet 731a of the second compartment 730 into the second interior volume 733. In the illustrated embodiment, the second and third sealing elements 740b and 740c are configured so when they are in the closed position, the first fluid F1 can flow through the second interior volume 733, flow past portions of the second and third sealing elements 740b and 740c, and exit the second interior volume 733 via the outlet 732 of the second compartment 730. With the second and third sealing elements 740b and 740c in the closed position, the second and third fluids F2 and F3 are inhibited from entering the second interior volume 733.

The flow of the first fluid F1 can be stopped or inhibited by moving the first sealing element 740a to the closed position, thereby preventing the first fluid F1 from flowing into the second interior volume 733. The second sealing element 740b can then be moved to the open position to allow the second fluid F2 to flow through the third passageway 710c, flow through the second in!et 731b of the second compartment 730, flow through the second interior volume 733 past at least a portion of the third sealing element 740c, and exit into the fifth passageway 710e via the outlet 732 of the second compartment 730.

The second sealing element 740b can then be moved to the closed position to inhibit the flow of the second fluid F2 into the second interior volume 733 of the second compartment 730. The first sealing element 740a can then be opened, allowing the first fluid F1 to flow into the second interior volume 733, flow through the second interior volume 733 past at least portions of the second and third sealing elements 740b and 740c, and exit the second interior volume 733 via the outlet 732 of the second compartment 730. For example, if the first fluid F1 is a purge fluid, the second fluid F2 is a first precursor, and the third fluid F3 is a second precursor in an ALD process, the flow of the first fluid F1 can serve to purge the second interior volume (and an associated chamber) after the first precursor has been applied.

The flow of the first fluid F1 can again be stopped or inhibited by moving the first sealing element 740a to the closed position, thereby preventing the first fluid F1 from flowing into the second interior volume 733. The third sealing element 740c can then be moved to the open position to allow the third fluid F3 to flow through the fourth passageway 710d, flow through the third inlet 731c of the second compartment 730, flow through the second interior volume 733, and exit into the fifth passageway 710e via the outlet 732 of the second compartment 730. The process described above can be repeated multiple times, for example, to control the flow of the precursor fluids and the purge fluid for an ALD process.

Features and advantages of embodiments discussed above with reference to FIG. 7 are similar to those discussed above with reference to FIGS. 3-6.

Additionally, in other embodiments the valve assembly 705 discussed above with reference to FIG. 7 can have other arrangements, including more, fewer, and/or different components.

D. Microfeature Workpiece Processing System Having a Valve Assembly that Controls the Flow of at Least Two Fluids and Associated Methods

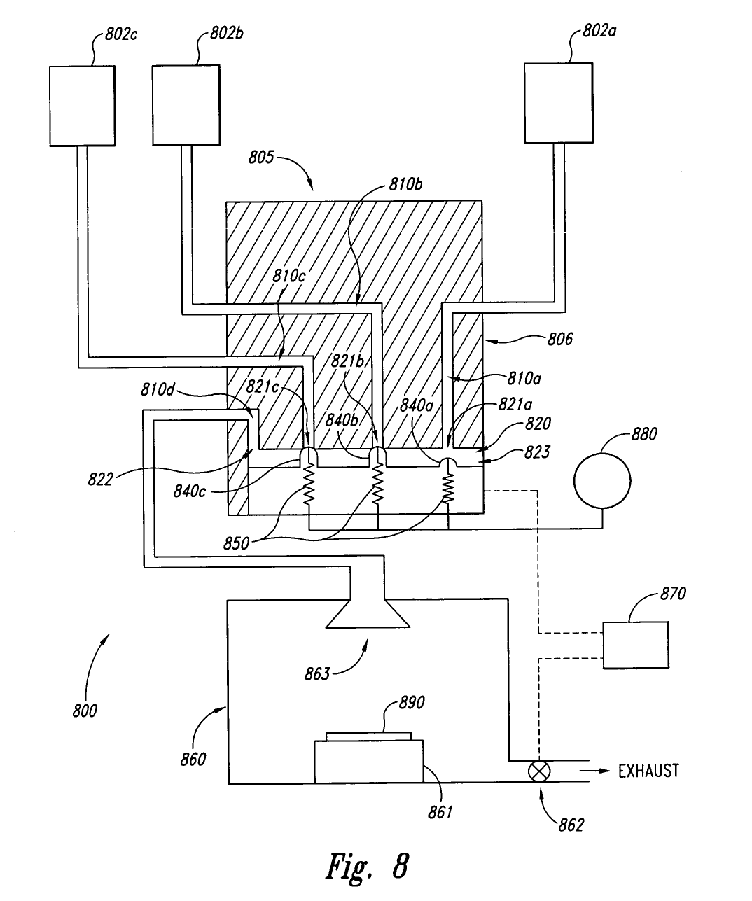

FIG. 8 is a partially schematic cross-sectional view of a microfeature workpiece processing system 800 having at least one valve assembly 805 that controls the flow of at least two fluids, in accordance with yet other embodiments of the invention. In FIG. 8, the valve assembly 805 has a first passageway 810a coupled to a first fluid reservoir 802a, a second passageway 810b coupled to a second fluid reservoir 802b, a third passageway 810c coupled to a third fluid reservoir 802c, and a fourth passageway 810d coupled to a dispersal element 863 in a processing chamber 860. In the illustrated embodiment, the first fluid reservoir 802a is configured to carry a purge fluid, the second fluid reservoir 802b is configured to carry a first precursor, and the third fluid reservoir 802c is configured to carry a second precursor. The valve assembly 805 is configured to control the flow of the first precursor, the second precursor, and the purge fluids during an ALD process.

For example, in the illustrated embodiment a controller 870 (e.g., a computer or digital processor) is coupled to actuators 850 of the valve assembly 805 and to an exhaust device 862 of the processing chamber 860. The controller 870 is configured to control the valve assembly 805 and the exhaust device 862 during an ALD process. Accordingly, one or more microfeature workpiece(s) 890 can be placed on a workpiece support 861 in the processing chamber 860, and the ALD process can be performed.

In FIG. 8, the valve assembly 805 includes a body 806 that carries a compartment 820 with an interior volume 823 configured to carry fluid, a first inlet 821a coupled to the first passageway 810a, a second inlet 821b coupled to the second passageway 810b, a third inlet 821c coupled to the third passageway 810c, and an outlet 822 in fluid communication with the fourth passageway 810d. In the illustrated embodiment, a first sealing element 840a, a second sealing element 840b, and a third sealing element 840c (referred to collectively as sealing elements 840) are located within, or proximate to, the interior volume 823. Each sealing element 840 is coupled to an actuator. The actuators are each coupled to one or more power source(s) 880 (e.g., a pneumatic, hydraulic, and/or electrical source) and are configured to move their respective sealing element 840 between open and closed positions.

In the illustrated embodiment, when the first sealing element 840a is in the open position (as shown in FIG. 8) the first sealing element 840a is positioned so that the first passageway is in fluid communication with the interior volume 823 via the first inlet 821a. In the open position, at least a portion of the first sealing element 840a is within the interior volume 823 or forms a portion of the surface defining the interior volume 823. In the closed position, the first sealing element 840a is positioned to inhibit or prevent substantial fluid flow from the first passageway 810a through the first inlet 821a into the interior volume 823. For example, in the closed position the first sealing element 840a can be positioned to block the first inlet 821a, thereby preventing substantial fluid flow through the first inlet 821a (e.g., preventing all fluid flow or allowing only a small amount of fluid flow through the outlet).

In FIG. 8, when the second sealing element 840b is in the open position, the second sealing element 840b is positioned so that the second passageway 810b is in fluid communication with the interior volume 823 via the second inlet 821b. In the open position, at least a portion of the second sealing element 840b is within the interior volume 823 or forms a portion of the surface defining the interior volume 823. In the closed position, the second sealing element 840b is positioned to inhibit or prevent substantial fluid flow from the second passageway 810b into the interior volume 823. For example, in the closed position the second sealing element 840b can be positioned to block the second inlet 821b, thereby inhibiting fluid flow from the second passageway 810b through second inlet 821b into the interior volume 823.

In the illustrated embodiment, when the third sealing element 840c is in the open position, the third sealing element 840c is positioned so that the third passageway 810c is in fluid communication with the interior volume 823 via the third inlet 821c. In the open position, at least a portion of the third sealing element 840c is within the interior volume 823 or forms a portion of the surface defining the interior volume 823. In the closed position, the third sealing element 840c is positioned to inhibit or prevent substantial fluid flow from the third passageway 810c into the interior volume 823. For example, in the closed position the third sealing element 840c can be positioned to block the third inlet 821c, thereby inhibiting fluid flow from the third passageway 810c through the third inlet 821c into the interior volume 823.

In FIG. 8, the second and third sealing elements 840b and 840c are located downstream of the first sealing element 840a (e.g., downstream in the flow path of the purge fluid carried in the first fluid reservoir 802a). For example, when the first sealing element 840a is in the open position, and the second and third sealing elements 840b and 840c are in the closed position (as shown in FIG. 8), the flow path of the purge fluid is through the first passageway 810a, through the first inlet 821a, and into the interior volume 823. In the illustrated embodiment, the second and third sealing elements 840b and 840c are configured so that when they are in the closed position, the purge fluid can flow through the interior volume 823, flow past portions of the second and third sealing elements 840b and 840c, and exit the interior volume 823 via the outlet 832. The fourth passageway 810d then carries the purge gas to the processing chamber 860. The exhaust device 862 can allow fluid to exit the processing chamber 860.

With the second and third sealing elements 840b and 840c in the closed position, the first and second precursors are inhibited from entering the interior volume 823.

The flow of the purge fluid can be stopped or inhibited by moving the first sealing element 840a to the closed position. The second sealing element 840b can then be moved to the open position to allow the first precursor to flow through the second passageway 810b, through the second inlet 821b, and through the interior volume 823 past at least a portion of the third sealing element 840c. The precursor can then exit into the fourth passageway 810d via the outlet 822 and flow into the processing chamber 860. In certain embodiments, the exhaust device 862 can be positioned to allow fluids to exit from the processing chamber 860.

The second sealing element 840b can then be moved to the closed position to inhibit the flow of the first precursor into the interior volume 823. The first sealing element 840a can then be opened, allowing the purge fluid to flow through the interior volume 823, past at least portions of the second and third sealing elements 840b and 840c, and into the processing chamber 860, purging the interior volume 823 and the processing chamber 860. In selected embodiments, the exhaust device 862 can be positioned to allow fluid to exit the processing chamber 860.

The flow of the purge fluid can again be stopped or inhibited by moving the first sealing element 840a to the closed position. The third sealing element 840c can then be moved to the open position to allow the second precursor to flow through the third passageway 810c, flow through the third inlet 821c, flow through the interior volume 823, and exit into the fourth passageway 810d via the outlet 822. The second precursor can then flow to the processing chamber 860 via the fourth passageway 810d. In selected embodiments, the exhaust device 862 can be positioned to allow fluid to exit the processing chamber 860. The process described above can be repeated multiple times to complete subsequent cycles of the ALD process.

Features and advantages of embodiments discussed above with reference to FIG. 8 are similar to those discussed above with reference to FIGS. 3-7. Additionally, in other embodiments the microfeature workpiece processing system 800 discussed above with reference to FIG. 8 can have other arrangements, including more, fewer, and/or different components. For example, in other embodiments the processing system 800 can include more or fewer reservoirs, more or fewer passageways, and/or more valve assemblies. For instance, in other embodiments the valve assembly 805 can be replaced by one or more of the valve assemblies discussed above with reference to FIGS. 3-7. In one embodiment the microfeature workpiece processing system 800 can include two valve assemblies similar to the valve assembly shown in FIGS. 3 and 4. The first of these valve assemblies can be coupled to the first fluid reservoir 802a and to the second fluid reservoir 802b. The second of these valve assemblies can be coupled to the first fluid reservoir 802a and the third fluid reservoir 802c. Accordingly, the chamber and one or both valve(s) can be purged between applications of the second and third fluids. Additionally, although the processing system in FIG. 8 was discussed in the context of an ALD process, in other embodiments the processing system 800 can be configured to perform other fluid based processes.

From the foregoing, it will be appreciated that specific embodiments of the invention have been described herein for purposes of illustration, but that various modifications may be made without deviating from the invention. For example, although many of the embodiments discussed above have been discussed in the context of processing microfeature workpieces, the valve assembly can be used to control fluid flow in any fluid based application. Additionally, aspects of the invention described in the context of particular embodiments may be combined or eliminated in other embodiments. Furthermore, while advantages associated with certain embodiments of the invention have been described in the context of those embodiments, other embodiments may also exhibit such advantages, and not all embodiments need necessarily exhibit such advantages to fall within the scope of the invention. Accordingly, the invention is not limited except as by the appended claims.

I/We claim:

1. A valve assembly for controlling the flow of at least two fluids for use in processing a microfeature workpiece, the assembly comprising:
a compartment having an interior volume configured to contain a fluid, a first inlet to the interior volume, a second inlet to the interior volume, and an outlet from the interior volume;
a first passageway coupled to the first inlet;
a second passageway coupled to the second inlet;
a first sealing element movable between an open position in which the first passageway and first inlet are open to the interior volume of the compartment and a closed position in which the first sealing element is positioned to inhibit fluid flow through the first passageway into the interior volume of the compartment; and
a second sealing element movable between an open position in which the second passageway and the second inlet are open to the interior volume of the compartment and a closed position in which the second sealing element blocks the second inlet to inhibit fluid flow through the second inlet, wherein at least a portion of the second sealing element is within the interior volume of the compartment or forms a portion of the surface defining the interior volume of the compartment.

2. The assembly of claim 1 wherein when the first sealing element is in the open position at least a portion of the first sealing element is within the interior volume of the compartment or forms a portion of the surface defining the interior volume of the compartment.

3. The assembly of claim 1 wherein the second sealing element is configured so that when the first sealing element is in the open position and the second sealing element is in the closed position, fluid can flow into the compartment via the first inlet, flow past at least a portion of the second sealing element, and exit the compartment via the outlet.

4. The assembly of claim 1 wherein the compartment includes a first compartment and wherein the assembly further comprises a second compartment having an interior volume configured to contain a fluid, an inlet to the interior volume of the second compartment, and an outlet coupled to the first passageway, wherein when the first sealing element is in the open position the inlet of the second compartment is in fluid communication with the first inlet of the first compartment via the interior volume of the second compartment, the outlet of the second compartment, and the first passageway, and wherein when the first sealing element is in the closed position the first sealing element is positioned to inhibit fluid flow from the inlet of the second compartment into the first passageway.

5. The assembly of claim 1 wherein the compartment includes a third inlet and wherein the assembly further comprises:
a third passageway in fluid communication with the third inlet; and
a third sealing element movable between an open position in which third passageway is in fluid communication with the interior volume of the compartment via the third inlet and a closed position in which the third sealing element closes the third inlet to inhibit fluid flow through the third inlet, wherein at least a portion of the first sealing element is within the interior volume of the compartment or forms a portion of the surface defining the interior volume of the compartment.

6. The assembly of claim 1 wherein the compartment includes a third inlet and wherein the assembly further comprises:
a third passageway in fluid communication with the third inlet; and
a third sealing element movable between an open position in which third passageway is in fluid communication with the interior volume of the compartment via the third inlet and a closed position in which the third sealing element closes the third inlet to inhibit fluid flow through the third inlet, wherein when the first sealing element is in the open position and the second and third sealing elements are in the closed position, fluid can flow into the compartment via the first inlet, flow past the second and third sealing elements, and exit the compartment via the outlet.

7. The assembly of claim 1 further comprising an actuator coupled to at least one of the first sealing element and the second sealing element.

8. A valve assembly for controlling the flow of at least two fluids for use in processing a microfeature workpiece, the assembly comprising:
a compartment having an interior volume configured to contain a fluid, a first inlet to the interior volume, a second inlet to the interior volume, and an outlet from the interior volume;
a first passageway coupled to the first inlet;
a second passageway coupled to the second inlet;
a first sealing element movable between an open position in which the first passageway and first inlet are open to the interior volume of the compartment and a closed position in which the first sealing element is positioned to inhibit fluid flow through the first passageway into the interior volume of the compartment; and
a second sealing element movable between an open position in which the second passageway and the second inlet are open to the interior volume of the compartment and a closed position in which the second sealing element blocks the second inlet to inhibit fluid flow through the second inlet, the second sealing element being located downstream of the first sealing element and configured so that when the first sealing element is in the open position and the second sealing element is in the closed position, fluid can enter the interior volume through the first inlet, pass by a portion of the second sealing element while in the interior volume, and exit the interior volume via the outlet.

9. The assembly of claim 8 wherein when the first sealing element is in the open position at least a portion of the first sealing element is within the interior volume of the compartment or forms a portion of the surface defining the interior volume of the compartment.

10. The assembly of claim 8 wherein when the second sealing element is in the open position at least a portion of the second sealing element is within the interior volume of the compartment or forms a portion of the surface defining the interior volume of the compartment.

11. The assembly of claim 8 wherein the compartment includes a first compartment and wherein the assembly further comprises a second compartment having an interior volume configured to contain a fluid, an inlet to the interior volume of the second compartment, and an outlet coupled to the first passageway, wherein when the first sealing element is in the open position the inlet of the second compartment is in fluid communication with the first inlet of the first compartment via the interior volume of the second compartment, the outlet of the second compartment, and the first passageway, and wherein when the first sealing element is in the closed position the first sealing element is positioned to inhibit fluid flow from the inlet of the second compartment into the first passageway.

12. The assembly of claim 8 wherein the compartment includes a third inlet and wherein the assembly further comprises:
a third passageway in fluid communication with the third inlet; and
a third sealing element movable between an open position in which third passageway is in fluid communication with the interior volume of the compartment via the third inlet and a closed position in which the third sealing element closes the third inlet to inhibit fluid flow through the third inlet, wherein at least a portion of the first sealing element is within the interior volume of the compartment or forms a portion of the surface defining the interior volume of the compartment.

13. The assembly of claim 8 wherein the compartment includes a third inlet and wherein the assembly further comprises:
a third passageway in fluid communication with the third inlet; and
a third sealing element movable between an open position in which third passageway is in fluid communication with the interior volume of the compartment via the third inlet and a closed position in which the third sealing element closes the third inlet to inhibit fluid flow through the third inlet, wherein when the first sealing element is in the open position and the second and third sealing elements are in the closed position, fluid can flow into the compartment via the first inlet, flow past the second and third sealing elements, and exit the compartment via the outlet.

14. A microfeature workpiece processing system having a valve assembly that controls the flow of at least two fluids, the system comprising:
a processing chamber configured to hold a microfeature workpiece during processing,
a first fluid reservoir;
a second fluid reservoir; and
a valve assembly operably coupled to the processing chamber, the first fluid reservoir, and the second fluid reservoir, the valve assembly comprising:
a compartment having an interior volume configured to contain fluid, a first inlet to the interior volume, a second inlet to the interior volume, and an outlet from the interior volume, the outlet being coupled to the processing chamber;
a first passageway coupled to the first inlet and the first fluid reservoir;
a second passageway coupled to the second inlet and the second fluid reservoir;
a first sealing element movable between an open position in which the first passageway and first inlet are open to the interior volume of the compartment and a closed position in which the first sealing element is positioned to inhibit fluid flow through the first passageway into the interior volume of the compartment; and
a second sealing element movable between an open position in which the second passageway and the second inlet are open to the interior volume of the compartment and a closed position in which the second sealing element blocks the second inlet to inhibit fluid flow through the second inlet, wherein at least a portion of the second sealing element is within the interior volume of the compartment or forms a portion of the surface defining the interior volume of the compartment.

15. The system of claim 14 wherein when the first sealing element is in the open position at least a portion of the first sealing element is within the interior volume of the compartment or forms a portion of the surface defining the interior volume of the compartment.

16. The system of claim 14 wherein the second sealing element is configured so that when the first sealing element is in the open position and the second sealing element is in the closed position, fluid can flow into the compartment via the first inlet, flow past at least a portion of the second sealing element, and exit the compartment via the outlet.

17. The system of claim 14 wherein the compartment includes a first compartment and wherein the assembly further comprises a second compartment having an interior volume configured to contain a fluid, an inlet to the interior volume of the second compartment, and an outlet coupled to the first passageway, wherein when the first sealing element is in the open position the inlet of the second compartment is in fluid communication with the first inlet of the first compartment via the interior volume of the second compartment, the outlet of the second compartment, and the first passageway, and wherein when the first sealing element is in the closed position the first sealing element is positioned to inhibit fluid flow from the inlet of the second compartment into the first passageway.

18. The system of claim 14 wherein the compartment includes a third inlet and wherein the valve assembly further comprises:
a third fluid reservoir;
a third passageway in fluid communication with the third inlet and the third fluid reservoir; and
a third sealing element movable between an open position in which third passageway is in fluid communication with the interior volume of the compartment via the third inlet and a closed position in which the third sealing element closes the third inlet to inhibit fluid flow through the third inlet, wherein at least a portion of the first sealing element is within the interior volume of the compartment or forms a portion of the surface defining the interior volume of the compartment.

19. The system of claim 14 wherein the compartment includes a third inlet and wherein the valve assembly further comprises:
a third fluid reservoir;
a third passageway in fluid communication with the third inlet and the third fluid reservoir; and
a third sealing element movable between an open position in which third passageway is in fluid communication with the interior volume of the compartment via the third inlet and a closed position in which the third sealing element closes the third inlet to inhibit fluid flow through the third inlet, wherein when the first sealing element is in the open position and the second and third sealing elements are in the closed position, fluid can flow into the compartment via the first inlet, flow past the second and third sealing elements, and exit the compartment via the outlet.

20. A microfeature workpiece processing system having a valve assembly that controls the flow of at least two fluids, the system comprising:
a processing chamber configured to hold a microfeature workpiece during processing,
a first fluid reservoir;
a second fluid reservoir; and
a valve assembly operably coupled to the processing chamber, the first fluid reservoir, and the second fluid reservoir, the valve assembly comprising:
a compartment having an interior volume configured to contain fluid, a first inlet to the interior volume, a second inlet to the interior volume, and an outlet from the interior volume, the outlet being coupled to the processing chamber;
a first passageway coupled to the first inlet and the first fluid reservoir;
a second passageway coupled to the second inlet and the second fluid reservoir;
first sealing means movable between an open position in which the first passageway and first inlet are open to the interior volume of the compartment and a closed position in which the first sealing means inhibits fluid flow through the first passageway into the interior volume of the compartment; and
second sealing means movable between an open position in which the second passageway and the second inlet are open to the interior volume of the compartment and a closed position in which the second sealing means blocks the second inlet to inhibit fluid flow through the second inlet, the second sealing means being located downstream of the first sealing means and configured so that when the first sealing means is in the open position and the second sealing means is in the closed position a first fluid can enter the interior volume via the first inlet, flow past at least a portion of the second sealing means while in the interior volume, and exit the interior volume via the outlet.

21. The system of claim 20 wherein when the first sealing means is in the open position at least a portion of the first sealing means is within the interior volume of the compartment or forms a portion of the surface defining the interior volume of the compartment.

22. The system of claim 20 wherein when the second sealing means is in the open position at least a portion of the second sealing means is within the interior volume of the compartment or forms a portion of the surface defining the interior volume of the compartment.

23. The system of claim 20 wherein the compartment includes a first compartment and wherein the assembly further comprises a second compartment having an interior volume configured to contain a fluid, an inlet to the interior volume of the second compartment, and an outlet coupled to the first passageway, wherein when the first sealing means is in the open position the inlet of the second compartment is in fluid communication with the first inlet of the first compartment via the interior volume of the second compartment, the outlet of the second compartment, and the first passageway, and wherein when the first sealing means is in the closed position the first sealing means is positioned to inhibit fluid flow from the inlet of the second compartment into the first passageway.

24. The system of claim 20 wherein the compartment includes a third inlet and wherein the valve assembly further comprises:
a third fluid reservoir;
a third passageway in fluid communication with the third inlet and the third fluid reservoir; and
third sealing means movable between an open position in which third passageway is in fluid communication with the interior volume of the compartment via the third inlet and a closed position in which the third sealing means closes the third inlet to inhibit fluid flow through the third inlet, wherein at least a portion of the first sealing means is within the interior volume of the compartment or forms a portion of the surface defining the interior volume of the compartment.

25. The system of claim 20 wherein the compartment includes a third inlet and wherein the valve assembly further comprises:
a third fluid reservoir;
a third passageway in fluid communication with the third inlet and the third fluid reservoir; and
third sealing means movable between an open position in which third passageway is in fluid communication with the interior volume of the compartment via the third inlet and a closed position in which the third sealing means closes the third inlet to inhibit fluid flow through the third inlet, wherein when the first sealing means is in the open position and the second and third sealing means are in the closed position, fluid can flow into the compartment via the first inlet, flow past the second and third sealing means, and exit the compartment via the outlet.

26. A method for making a valve assembly for controlling the flow of at least two fluids for use in processing a microfeature workpiece, the method comprising:
forming a compartment in a body, the compartment having an interior volume configured to carry a fluid, a first inlet configured to allow fluid to enter the interior volume, a second inlet configured to allow fluid to enter the interior volume, and an outlet configured to allow fluid to exit the interior volume;
coupling a first passageway to the first inlet;
coupling a second passageway to the second inlet;
locating a first sealing element relative to the first passageway and the first inlet to control fluid flow through the first inlet, the first sealing element being movable between an open position and a closed position, in the open position the first sealing element being positioned so that the first passageway is in fluid communication with the interior volume of the compartment via the first inlet, in the closed position the first sealing element being positioned to inhibit fluid flow through the first passageway into the interior volume of the compartment; and
locating a second sealing element relative to the compartment and the second inlet to control fluid flow through the second inlet, the second sealing element being movable between an open position and a closed position, in the closed position the second sealing element being positioned to block the second inlet to inhibit fluid flow through the second inlet, in the open position the second sealing element being positioned so that the second passageway is in fluid communication with the interior volume of the compartment via the second inlet and so that at least a portion of the second sealing element is within the interior volume of the compartment or forms a portion of the surface defining the interior volume of the compartment.

27. The method of claim 26 further comprising at least one of coupling a first fluid reservoir to the first passageway and coupling a second fluid reservoir to the second passageway.

28. The method of claim 26 further comprising coupling the outlet to a processing chamber configured to hold a microfeature workpiece during processing.

29. The method of claim 26 wherein forming a compartment includes forming a first compartment and wherein the method further comprises:
forming a second compartment having an interior volume configured to carry a fluid, an inlet configured to allow fluid to flow into the interior volume of the second compartment, and an outlet; and
coupling the outlet of the second compartment to the first passageway, wherein when the first sealing element is in the open position the inlet of the second compartment is in fluid communication with the first inlet of the first compartment via the interior volume of the second compartment, the outlet of the second compartment, and the first passageway, and wherein when the first sealing element is in the closed position the first sealing element is positioned to inhibit fluid flow from the inlet of the second compartment into the first passageway.

30. The method of claim 26 wherein forming a compartment includes forming a compartment having a third inlet and wherein the method further comprises:
coupling a third passageway to the third inlet; and
locating a third sealing element relative to the compartment and the third inlet to control fluid flow through the second inlet, the third sealing element being movable between an open position and a closed position, in the closed position the third sealing element being positioned to block the third inlet to inhibit fluid flow through the third inlet, in the open position the third sealing element being positioned so that the third passageway is in fluid communication with the interior volume of the compartment via the third inlet and so that at least a portion of the first sealing element is within the interior volume of the compartment or forms a portion of the surface defining the interior volume of the compartment.

31. The method of claim 26 wherein forming a compartment includes forming a compartment having a third inlet and wherein the method further comprises:
coupling a third passageway to the third inlet; and
locating a third sealing element relative to the compartment and the third inlet to control fluid flow through the second inlet, the third sealing element being movable between an open position and a closed position, in the open position the third sealing element being positioned so that the third passageway is in fluid communication with the interior volume of the compartment via the third inlet, in the closed position the third sealing element being positioned to block the third inlet to inhibit fluid flow through the third inlet, and wherein when the first sealing element is in the open position and the second and third sealing elements are in the closed position, fluid can flow into the compartment via the first inlet, flow past the second and third sealing elements, and exit the compartment via the outlet.

32. A method for making a valve assembly for controlling the flow of at least two fluids for use in processing a microfeature workpiece, the method comprising:
forming a compartment in a body, the compartment having an interior volume configured to carry a fluid, a first inlet configured to allow fluid to enter the interior volume, a second inlet configured to allow fluid to enter the interior volume, and an outlet configured to allow fluid to exit the interior volume;
coupling a first passageway to the first inlet;
coupling a second passageway to the second inlet;
locating a first sealing element relative to the first passageway and the first inlet to control fluid flow through the first inlet, the first sealing element being movable between an open position and a closed position, in the open position the first sealing element being positioned so that the first passageway is in fluid communication with the interior volume of the compartment via the first inlet, in the closed position the first sealing element being positioned to inhibit fluid flow through the first passageway into the interior volume of the compartment; and
locating a second sealing element relative to the compartment and the second inlet to control fluid flow through the second inlet, the second sealing element being movable between an open position and a closed position, in the closed position the second sealing element being positioned to block the second inlet to inhibit fluid flow through the second inlet, in the open position the second sealing element being positioned so that the second passageway is in fluid communication with the interior volume of the compartment via the second inlet, the second sealing element being located downstream of the first sealing element and configured so that when the first sealing element is in the open position and the second sealing element is in the closed position, fluid can enter the interior volume through the first inlet, pass by a portion of the second sealing element while in the interior volume, and exit the interior volume via the outlet.

33. The method of claim 32 further comprising at least one of coupling a first fluid reservoir to the first passageway and coupling a second fluid reservoir to the second passageway.

34. The method of claim 32 further comprising coupling the outlet to a processing chamber configured to hold a microfeature workpiece during processing.

35. The method of claim 32 wherein forming a compartment includes forming a first compartment and wherein the method further comprises:
forming a second compartment having an interior volume configured to carry a fluid, an inlet configured to allow fluid to flow into the interior volume of the second compartment, and an outlet; and
coupling the outlet of the second compartment to the first passageway, wherein when the first sealing element is in the open position the inlet of the second compartment is in fluid communication with the first inlet of the first compartment via the interior volume of the second compartment, the outlet of the second compartment, and the first passageway, and wherein when the first sealing element is in the closed position the first sealing element is positioned to inhibit fluid flow from the inlet of the second compartment into the first passageway.

36. The method of claim 32 wherein forming a compartment includes forming a compartment having a third inlet and wherein the method further comprises:
coupling a third passageway to the third inlet; and
locating a third sealing element relative to the compartment and the third inlet to control fluid flow through the second inlet, the third sealing element being movable between an open position and a closed position, in the closed position the third sealing element being positioned to block the third inlet to inhibit fluid flow through the third inlet, in the open position the third sealing element being positioned so that the third passageway is in fluid communication with the interior volume of the compartment via the third inlet and so that at least a portion of the first sealing element is within the interior volume of the compartment or forms a portion of the surface defining the interior volume of the compartment.

37. The method of claim 32 wherein forming a compartment includes forming a compartment having a third inlet and wherein the method further comprises:
coupling a third passageway to the third inlet; and
locating a third sealing element relative to the compartment and the third inlet to control fluid flow through the second inlet, the third sealing element being movable between an open position and a closed position, in the open position the third sealing element being positioned so that the third passageway is in fluid communication with the interior volume of the compartment via the third inlet, in the closed position the third sealing element being positioned to block the third inlet to inhibit fluid flow through the third inlet, and wherein when the first sealing element is in the open position and the second and third sealing elements are in the closed position, fluid can flow into the compartment via the first inlet, flow past the second and third sealing elements, and exit the compartment via the outlet.

38. A method for controlling the flow of at least two fluids for use in processing a microfeature workpiece, the method comprising:
moving a first sealing element to a closed position where the first sealing element inhibits a first fluid from flowing through a first inlet of a compartment into an interior volume of the compartment;
moving a second sealing element to an open position where a second fluid is allowed to flow through a second inlet of the compartment into the interior volume of the compartment and exit the interior volume via an outlet of the compartment;
moving the second sealing element to a closed position where the second sealing element blocks the second inlet to inhibit the second fluid from flowing through the second inlet; and
moving the first sealing element to an open position where the first sealing element allows the first fluid to flow through the first inlet, the second sealing element being located downstream of the first sealing element and configured so that when the first sealing element is in the open position and the second sealing element is in the closed position, the first fluid enters the interior volume through the first inlet, passes by a portion of the second sealing element while in the interior volume, and exits the interior volume via the outlet.

39. The method of claim 38 wherein:
moving the second sealing element to an open position includes moving the second sealing element to an open position where a second fluid is allowed to flow from a second fluid reservoir, though a second passageway, and through a second inlet into the interior volume; and
moving the first sealing element to an open position includes moving the first sealing element to an open position where a first fluid is allowed to flow from a first fluid reservoir, though a first passageway, and through a first inlet into the interior volume.

40. The method of claim 38 wherein:
moving the second sealing element to an open position includes moving the second sealing element to an open position where a second fluid is allowed to flow through a second inlet into the interior volume, exit the interior volume via an outlet, and flow though a passageway to a processing chamber; and
moving the first sealing element to an open position includes moving the first sealing element to an open position where a first fluid is allowed to flow through a first inlet into the interior volume, exit the interior volume via an outlet, and flow though a passageway to the processing chamber.

41. The method of claim 38 wherein:
moving the first sealing element to an open position where the first sealing element allows the first fluid to flow through the first inlet includes moving the first sealing element to an open position where the first sealing element allows a purge fluid to flow through the first inlet, the second sealing element being located downstream of the first sealing element and configured so that when the first sealing element is in the open position and the second sealing element is in the closed position, the purge fluid enters the interior volume through the first inlet, passes by a portion of the second sealing element while in the interior volume, and exits the interior volume via the outlet, thereby purging the interior volume with the flow or pressure of the purge fluid.

42. A method for controlling the flow of at least two fluids for use in processing a microfeature workpiece, the method comprising:
moving a first sealing element to a closed position where the first sealing element inhibits a first fluid from flowing through a first inlet of a compartment into an interior volume of the compartment;
moving a second sealing element to an open position where a second fluid is allowed to flow through a second inlet of the compartment into the interior volume of the compartment and exit the interior volume via an outlet of the compartment;
moving the second sealing element to a closed position where the second sealing element blocks the second inlet to inhibit the second fluid from flowing through the second inlet; and
moving the first sealing element to an open position where the first sealing element allows the first fluid to flow through the first inlet and exit the interior volume via the outlet, wherein at least a portion of the second sealing element is within the interior volume of the compartment or forms a portion of the surface defining the interior volume of the compartment.

43. A method for processing a microfeature workpiece comprising:
moving a first sealing element to a closed position where the first sealing element inhibits a first fluid from flowing through a first inlet of a compartment into an interior volume of the compartment;
moving a second sealing element to an open position where a second fluid is allowed to flow through a second inlet of the compartment, flow into the interior volume, exit the interior volume via an outlet of the compartment, and flow into a processing chamber carrying a microfeature workpiece;
moving the second sealing element to a closed position where the second sealing element blocks the second inlet to inhibit the second fluid from flowing through the second inlet; and moving the first sealing element to an open position where the first sealing element allows the first fluid to flow through the first inlet, the second sealing element being located downstream of the first sealing element and configured so that when the first sealing element is in the open position and the second sealing element is in the closed position, the first fluid enters the interior volume through the first inlet, passes by a portion of the second sealing element while in the interior volume, exits the interior volume via the outlet, and flows into the processing chamber carrying the microfeature workpiece.
